(19) United States
(12) Patent Application Publication
(10) Pub. No.: US 2022/0109558 A1
(43) Pub. Date: Apr. 7, 2022

(54) XMSS MANAGEMENT TO ADDRESS RANDOMIZED HASHING AND FEDERAL INFORMATION PROCESSING STANDARDS

(71) Applicant: Intel Corporation, Santa Clara, CA (US)

(72) Inventors: Vikram Suresh, Portland, OR (US); Santosh Ghosh, Hillsboro, OR (US); Shalini Sharma, Folsom, CA (US); Eduard Lecha, Fremont, CA (US); Manoj Sastry, Portland, OR (US); Xiaoyu Ruan, Folsom, CA (US); Sanu Mathew, Portland, OR (US)

(73) Assignee: Intel Corporation, Santa Clara, CA (US)

(21) Appl. No.: 17/551,525

(22) Filed: Dec. 15, 2021

(51) Int. Cl. H04L 9/06

(52) U.S. Cl. CPC H04L 9/0643

(57) ABSTRACT

In one example an apparatus comprises verification circuitry to store an object image in a computer readable memory external to an XMSS verifier circuitry and verify the object image by repeating operations to receive, in a local memory of the XMSS verifier circuitry, a fixed-sized block of data from the object image and process the fixed-sized block of data to compute the signature verification. Other examples may be described.

### BACKGROUND

Subject matter described herein relates generally to the field of computer security and more particularly to accelerators for post-quantum cryptography secure Extended Merkle Signature Scheme (XMSS) and Leighton/Micali Signature (LMS) hash-based signing and verification.

Existing public-key digital signature algorithms such as Rivest-Shamir-Adleman (RSA) and Elliptic Curve Digital Signature Algorithm (ECDSA) are anticipated not to be secure against brute-force attacks based on algorithms such as Shor's algorithm using quantum computers. As a result, there are efforts underway in the cryptography research community and in various standards bodies to define new standards for algorithms that are secure against quantum computers.

Accordingly, techniques to manage signature and verification schemes such as XMSS and LMS may find utility, e.g., in computer-based communication systems and methods.

### BRIEF DESCRIPTION OF THE DRAWINGS

The detailed description is described with reference to the accompanying figures.

FIGS. 1A and 1B are schematic illustrations of a one-time hash-based signatures scheme and a multi-time hash-based signatures scheme, respectively.

FIGS. 2A-2B are schematic illustrations of a one-time signature scheme and a multi-time signature scheme, respectively.

FIG. 3 is a schematic illustration of a signing device and a verifying device, in accordance with some examples.

FIG. 4A is a schematic illustration of a Merkle tree structure, in accordance with some examples.

FIG. 4B is a schematic illustration of a Merkle tree structure, in accordance with some examples.

FIG. 5 is a schematic illustration of a compute blocks in an architecture to implement a signature algorithm, in accordance with some examples.

FIG. 6A is a schematic illustration of a compute blocks in an architecture to implement signature generation in a signature algorithm, in accordance with some examples.

FIG. 6B is a schematic illustration of a compute blocks in an architecture to implement signature verification in a verification algorithm, in accordance with some examples.

FIG. 7 is a schematic illustration of compute blocks in an architecture to implement XMSS management to address randomized hashing and federal information processing standards, in accordance with some examples.

FIG. 8 is a flowchart illustrating operations in a method to implement power on self test (POST) processing, in accordance with some examples.

FIG. 9 is a flowchart illustrating operations in a method to implement XMSS management to address randomized hashing and federal information processing standards, in accordance with some examples.

FIG. 10 is a schematic illustration of a computing architecture which may be adapted to implement a hardware accelerator in accordance with some examples.

### DETAILED DESCRIPTION

Described herein are exemplary systems and methods to implement efficient hybridization of classical and post-quantum signatures. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the examples.

As described briefly above, existing public-key digital signature algorithms such as Rivest-Shamir-Adleman (RSA) and Elliptic Curve Digital Signature Algorithm (ECDSA) are anticipated not to be secure against brute-force attacks based on algorithms such as Shor's algorithm using quantum computers. The eXtended Merkle signature scheme (XMSS) and/or an eXtended Merkle many time signature scheme (XMSS-MT) are hash-based signature schemes that can protect against attacks by quantum computers. As used herein, the term XMSS shall refer to both the XMSS scheme and the XMSS-MT scheme.

An XMSS signature process implements a hash-based signature scheme using a one-time signature scheme such as a Winternitz one-time signature (WOTS) or a derivative there of (e.g., WOTS+) in combination with a secure hash algorithm (SHA) such as SHA2-256 as the primary underlying hash function. In some examples the XMSS signature/verification scheme may also use one or more of SHA2-512, SHA3-SHAKE-256 or SHA3-SHAKE-512 as secure hash functions. XMSS-specific hash functions include a Pseudo-Random Function (PRF), a chain hash (F), a tree hash (H) and message hash function (H_{msg}). As used herein, the term WOTS shall refer to the WOTS signature scheme and or a derivative scheme such as WOTS+.

The Leighton/Micali signature (LMS) scheme is another hash-based signature scheme that uses Leighton/Micali one-time signatures (LM-OTS) as the one-time signature building block. LMS signatures are based on a SHA2-256 hash function.

An XMSS signature process comprises three major operations. The first major operation receives an input message (M) and a private key (sk) and utilizes a one-time signature algorithm (e.g., WOTS+) to generate a message representative (M′) that encodes a public key (pk). In a 128-bit post quantum security implementation the input message M is subjected to a hash function and then divided into 67 message components (n bytes each), each of which are subjected to a hash chain function to generate the a corresponding 67 components of the digital signature. Each chain function invokes a series of underlying secure hash algorithms (SHA).

The second major operation is an L-Tree computation, which combines WOTS+ (or WOTS) public key components (n-bytes each) and produces a single n-byte value. For example, in the 128-bit post-quantum security there are 67 public key components, each of which invokes an underlying secure hash algorithm (SHA) that is performed on an input block.

The third major operation is a tree-hash operation, which constructs a Merkle tree. In an XMSS verification, an authentication path that is provided as part of the signature and the output of L-tree operation is processed by a tree-hash operation to generate the root node of the Merkle tree, which should correspond to the XMSS public key. For XMSS verification with 128-bit post-quantum security, traversing the Merkle tree comprises executing secure hash operations. In an XMSS verification, the output of the Tree-hash operation is compared with the known public key. If they match then the signature is accepted. By contrast, if they do not match then the signature is rejected.

### Post-Quantum Cryptography Overview

Post-Quantum Cryptography (also referred to as “quantum-proof”, “quantum-safe”, “quantum-resistant”, or simply “PQC”) takes a futuristic and realistic approach to cryptography. It prepares those responsible for cryptography as well as end-users to know the cryptography is outdated; rather, it needs to evolve to be able to successfully address the evolving computing devices into quantum computing and post-quantum computing.

It is well-understood that cryptography allows for protection of data that is communicated online between individuals and entities and stored using various networks. This communication of data can range from sending and receiving of emails, purchasing of goods or services online, accessing banking or other personal information using websites, etc.

Conventional cryptography and its typical factoring and calculating of difficult mathematical scenarios may not matter when dealing with quantum computing. These mathematical problems, such as discrete logarithm, integer factorization, and elliptic-curve discrete logarithm, etc., are not capable of withstanding an attack from a powerful quantum computer. Although any post-quantum cryptography could be built on the current cryptography, the novel approach would need to be intelligent, fast, and precise enough to resist and defeat any attacks by quantum computers

Today's PQC is mostly focused on the following approaches: 1) hash-based cryptography based on Merkle's hash tree public-key signature system of 1979, which is built upon a one-message-signature idea of Lamport and Diffie; 2) code-based cryptography, such as McEliece's hidden-Goppa-code public-key encryption system; 3) lattice-based cryptography based on Hoffstein-Pipher-Silverman public-key-encryption system of 1998; 4) multivariate-quadratic equations cryptography based on Patarin's HFE public-key-signature system of 1996 that is further based on the Matumoto-Imai proposal; 5) supersingular elliptical curve isogeny cryptography that relies on supersingular elliptic curves and supersingular isogeny graphs; and 6) symmetric key quantum resistance.

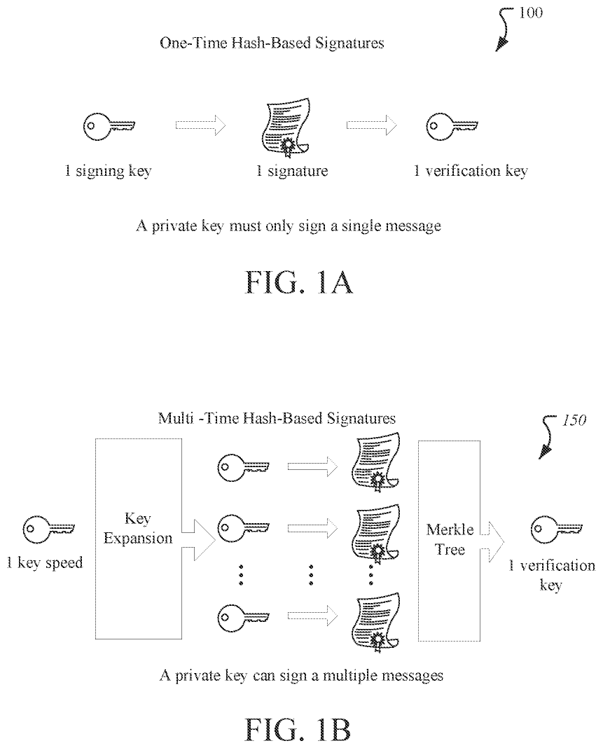

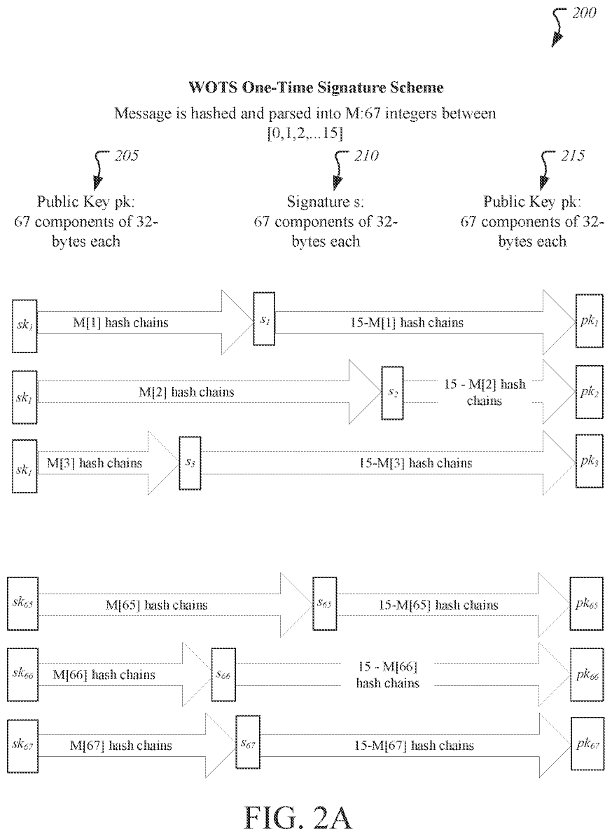

FIGS. 1A and 1B illustrate a one-time hash-based signatures scheme and a multi-time hash-based signatures scheme, respectively. As aforesaid, hash-based cryptography is based on cryptographic systems like Lamport signatures, Merkle Signatures, extended Merkle signature scheme (XMSS), and SPHINCs scheme, etc. With the advent of quantum computing and in anticipation of its growth, there have been concerns about various challenges that quantum computing could pose and what could be done to counter such challenges using the area of cryptography.

One area that is being explored to counter quantum computing challenges is hash-based signatures (HBS) since these schemes have been around for a long while and possess the necessarily basic ingredients to counter the quantum counting and post-quantum computing challenges. HBS schemes are regarded as fast signature algorithms working with fast platform secured-boot, which is regarded as the most resistant to quantum and post-quantum computing attacks.

For example, as illustrated with respect to FIG. 1A, a scheme of HBS is shown that uses Merkle trees along with a one-time signature (OTS) scheme 100, such as using a private key to sign a message and a corresponding public key to verify the OTS message, where a private key only signs a single message.

Similarly, as illustrated with respect to FIG. 1B, another HBS scheme is shown, where this one relates to multi-time signatures (MTS) scheme 150, where a private key can sign multiple messages.

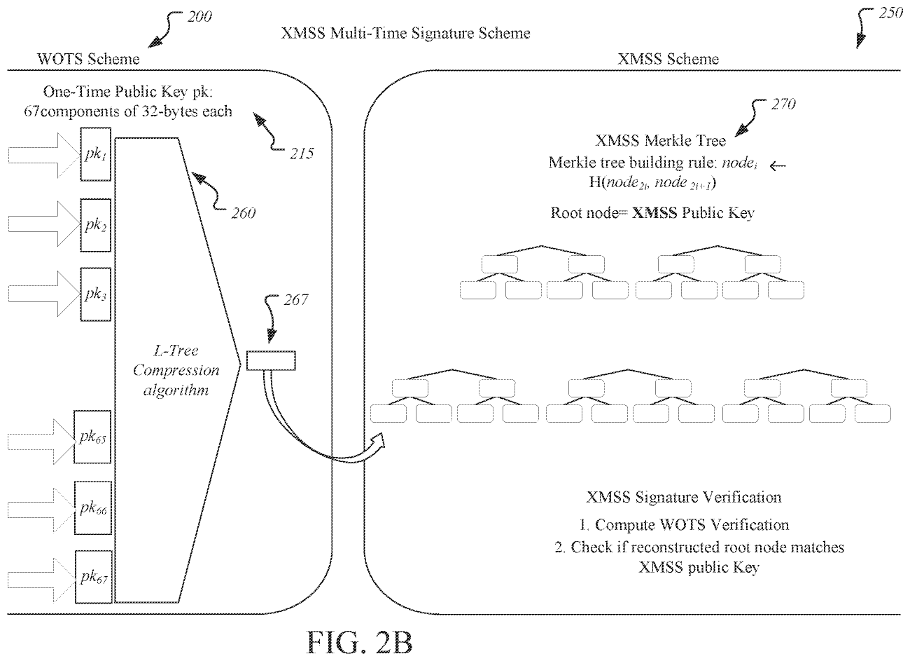

FIGS. 2A and 2B illustrate a one-time signature scheme and a multi-time signature scheme, respectively. Continuing with HBS-based OTS scheme 100 of FIG. 1A and MTS scheme 150 of FIG. 1B, FIG. 2A illustrates Winternitz OTS scheme 200, which was offered by Robert Winternitz of Stanford Mathematics Department publishing as hw(x) as opposed to h(x)|h(y), while FIG. 2B illustrates XMSS MTS scheme 250, respectively.

For example, WOTS scheme 200 of FIG. 2A provides for hashing and parsing of messages into M, with 67 integers between [0, 1, 2, . . . , 15], such as private key, sk, 205, signature, s, 210, and public key, pk, 215, with each having 67 components of 32 bytes each.

FIG. 2B illustrates XMSS MTS scheme 250 that allows for a combination of WOTS scheme 200 of FIG. 2A and XMSS scheme 255 having XMSS Merkle tree. As discussed previously with respect to FIG. 2A, WOTs scheme 200 is based on a one-time public key, pk, 215, having 67 components of 32 bytes each, that is then put through L-Tree compression algorithm 260 to offer WOTS compressed pk 265 to take a place in the XMSS Merkle tree of XMSS scheme 255. It is contemplated that XMSS signature verification may include computing WOTS verification and checking to determine whether a reconstructed root node matches the XMSS public key, such as root node=XMSS public key.

### Accelerators for Post-Quantum Cryptography

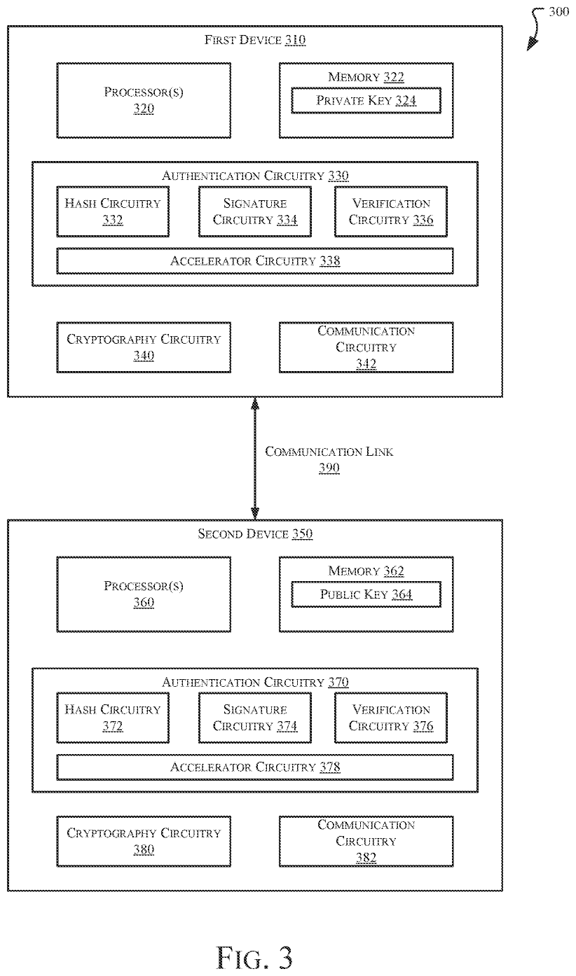

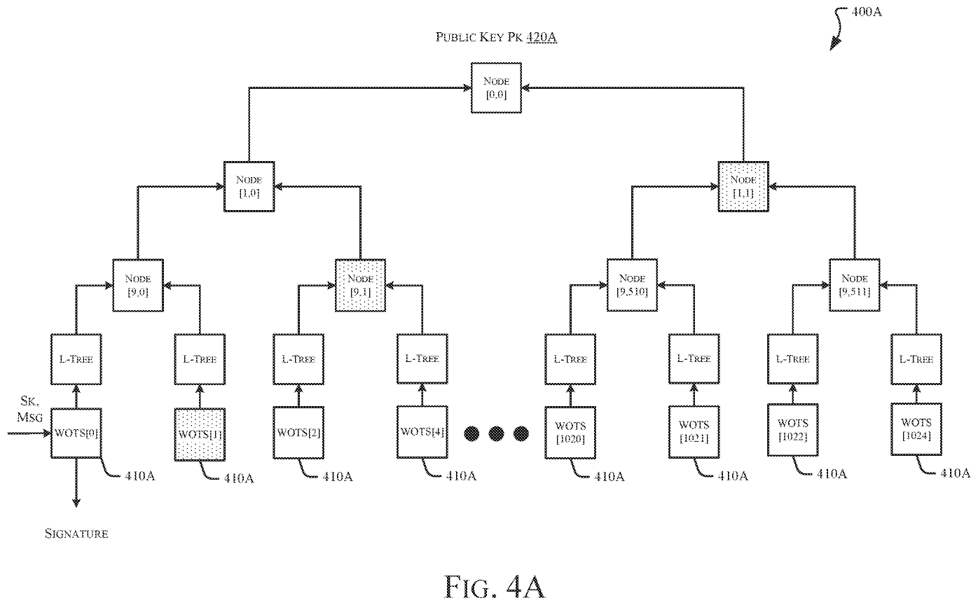

FIG. 3 is a schematic illustration of a high-level architecture of a secure environment 300 that includes a first device 310 and a second device 350, in accordance with some examples. Referring to FIG. 3, each of the first device 310 and the second device 350 may be embodied as any type of computing device capable of performing the functions described herein. For example, in some embodiments, each of the first device 310 and the second device 350 may be embodied as a laptop computer, tablet computer, notebook, netbook, Ultrabook™, a smartphone, cellular phone, wearable computing device, personal digital assistant, mobile Internet device, desktop computer, router, server, workstation, and/or any other computing/communication device.

First device 310 includes one or more processor(s) 320 and a memory 322 to store a private key 324. The processor(s) 320 may be embodied as any type of processor capable of performing the functions described herein. For example, the processor(s) 320 may be embodied as a single or multi-core processor(s), digital signal processor, microcontroller, or other processor or processing/controlling circuit. Similarly, the memory 322 may be embodied as any type of volatile or non-volatile memory or data storage capable of performing the functions described herein. In operation, the memory 322 may store various data and software used during operation of the first device 310 such as operating systems, applications, programs, libraries, and drivers. The memory 322 is communicatively coupled to the processor(s) 320. In some examples the private key 324 may reside in a secure memory that may be part memory 322 or may be separate from memory 322.

First device 310 further comprises authentication circuitry 330 which includes memory 332, signature circuitry, and verification circuitry 336. Hash circuitry 332 is configured to hash (i.e., to apply a hash function to) a message (M) to generate a hash value (m′) of the message M. Hash functions may include, but are not limited to, a secure hash function, e.g., secure hash algorithms SHA2-256 and/or SHA3-256, etc. SHA2-256 may comply and/or be compatible with Federal Information Processing Standards (FIPS) Publication 180-4, titled: “Secure Hash Standard (SHS)”, published by National Institute of Standards and Technology (NIST) in March 2012, and/or later and/or related versions of this standard. SHA3-256 may comply and/or be compatible with FIPS Publication 202, titled: “SHA-3 Standard: Permutation-Based Hash and Extendable-Output Functions”, published by NIST in August 2015, and/or later and/or related versions of this standard.

Signature circuitry 332 may be configured to generate a signature to be transmitted, i.e., a transmitted signature and/or to verify a signature. In instances in which the first device 310 is the signing device, the transmitted signature may include a number, L, of transmitted signature elements with each transmitted signature element corresponding to a respective message element. For example, for each message element, mᵢ, signature circuitry 332 may be configured to perform a selected signature operation on each private key element, sₖᵢ of the private key, sₖ, a respective number of times related to a value of each message element, mᵢ included in the message representative m′. For example, signature circuitry 332 may be configured to apply a selected hash function to a corresponding private key element, sₖᵢ, mᵢ times. In another example, signature circuitry 332 may be configured to apply a selected chain function (that contains a hash function) to a corresponding private key element, sₖᵢ, mᵢ times. The selected signature operations may, thus, correspond to a selected hash-based signature scheme.

Hash-based signature schemes may include, but are not limited to, a Winternitz (W) one time signature (OTS) scheme, an enhanced Winternitz OTS scheme (e.g., WOTS+), a Merkle many time signature scheme, an extended Merkle signature scheme (XMSS) and/or an extended Merkle multiple tree signature scheme (XMSS-MT), etc. Hash functions may include, but are not limited to SHA2-256 and/or SHA3-256, etc. For example, XMSS and/or XMSS-MT may comply or be compatible with one or more Internet Engineering Task Force (IETF®) informational draft Internet notes, e.g., draft draft-irtf-cfrg-xmss-hash-based-signatures-00, titled “XMSS: Extended Hash-Based Signatures, released April 2015, by the Internet Research Task Force, Crypto Forum Research Group of the IETF® and/or later and/or related versions of this informational draft, such as draft draft-irtf-cfrg-xmss-hash-based-signatures-06, released June 2016.

Winternitz OTS is configured to generate a signature and to verify a received signature utilizing a hash function. Winternitz OTS is further configured to use the private key and, thus, each private key element, sₖᵢ, one time. For example, Winternitz OTS may be configured to apply a hash function to each private key element, mᵢ or N-mᵢ times to generate a signature and to apply the hash function to each received message element N-m_{i′} or m_{i′} times to generate a corresponding verification signature element. The Merkle many time signature scheme is a hash-based signature scheme that utilizes an OTS and may use a public key more than one time. For example, the Merkle signature scheme may utilize Winternitz OTS as the one-time signature scheme. WOTS+ is configured to utilize a family of hash functions and a chain function.

XMSS, WOTS+ and XMSS-MT are examples of hash-based signature schemes that utilize chain functions. Each chain function is configured to encapsulate a number of calls to a hash function and may further perform additional operations. The number of calls to the hash function included in the chain function may be fixed. Chain functions may improve security of an associated hash-based signature scheme. Hash-based signature balancing, as described herein, may similarly balance chain function operations.

Cryptography circuitry 340 is configured to perform various cryptographic and/or security functions on behalf of the signing device 310. In some embodiments, the cryptography circuitry 340 may be embodied as a cryptographic engine, an independent security co-processor of the signing device 310, a cryptographic accelerator incorporated into the processor(s) 320, or a standalone software/firmware. In some embodiments, the cryptography circuitry 340 may generate and/or utilize various cryptographic keys (e.g., symmetric/asymmetric cryptographic keys) to facilitate encryption, decryption, signing, and/or signature verification. Additionally, in some embodiments, the cryptography circuitry 340 may facilitate to establish a secure connection with remote devices over communication link. It should further be appreciated that, in some embodiments, the cryptography module 340 and/or another module of the first device 310 may establish a trusted execution environment or secure enclave within which a portion of the data described herein may be stored and/or a number of the functions described herein may be performed.

After the signature is generated as described above, the message, M, and signature may then be sent by first device 310, e.g., via communication circuitry 342, to second device 350 via network communication link 390. In an embodiment, the message, M, may not be encrypted prior to transmission. In another embodiment, the message, M, may be encrypted prior to transmission. For example, the message, M, may be encrypted by cryptography circuitry 340 to produce an encrypted message.

Second device 350 may also include one or more processors 360 and a memory 362 to store a public key 364. As described above, the processor(s) 360 may be embodied as any type of processor capable of performing the functions described herein. For example, the processor(s) 360 may be embodied as a single or multi-core processor(s), digital signal processor, microcontroller, or other processor or processing/controlling circuit. Similarly, the memory 362 may be embodied as any type of volatile or non-volatile memory or data storage capable of performing the functions described herein. In operation, the memory 362 may store various data and software used during operation of the second device 350 such as operating systems, applications, programs, libraries, and drivers. The memory 362 is communicatively coupled to the processor(s) 360.

In some examples the public key 364 may be provided to verifier device 350 in a previous exchange. The public key, pₖ, is configured to contain a number L of public key elements, i.e., pₖ=[pₖ₁, . . . , p_{kL}]. The public key 364 may be stored, for example, to memory 362.

Second device 350 further comprises authentication circuitry 370 which includes hash circuitry 372, signature circuitry, and verification circuitry 376. As described above, hash circuitry 372 is configured to hash (i.e., to apply a hash function to) a message (M) to generate a hash message (m′). Hash functions may include, but are not limited to, a secure hash function, e.g., secure hash algorithms SHA2-256 and/or SHA3-256, etc. SHA2-256 may comply and/or be compatible with Federal Information Processing Standards (FIPS) Publication 180-4, titled: “Secure Hash Standard (SHS)”, published by National Institute of Standards and Technology (NIST) in March 2012, and/or later and/or related versions of this standard. SHA3-256 may comply and/or be compatible with FIPS Publication 202, titled: “SHA-3 Standard: Permutation-Based Hash and Extendable-Output Functions”, published by NIST in August 2015, and/or later and/or related versions of this standard.

In instances in which the second device is the verifying device, authentication circuitry 370 is configured to generate a verification signature based, at least in part, on the signature received from the first device and based, at least in part, on the received message representative (m′). For example, authentication circuitry 370 may configured to perform the same signature operations, i.e., apply the same hash function or chain function as applied by hash circuitry 332 of authentication circuitry 330, to each received message element a number, N-m_{i′} (or m_{i′}), times to yield a verification message element. Whether a verification signature, i.e., each of the L verification message elements, corresponds to a corresponding public key element, pₖᵢ, may then be determined. For example, verification circuitry 370 may be configured to compare each verification message element to the corresponding public key element, pₖᵢ. If each of the verification message element matches the corresponding public key element, pₖᵢ, then the verification corresponds to success. In other words, if all of the verification message elements match the public key elements, pₖ₁, . . . , p_{kL}, then the verification corresponds to success. If any verification message element does not match the corresponding public key element, pi, then the verification corresponds to failure.

As described in greater detail below, in some examples the authentication circuitry 330 of the first device 310 includes one or more accelerators 338 that cooperate with the hash circuitry 332, signature circuitry 334 and/or verification circuitry 336 to accelerate authentication operations. Similarly, in some examples the authentication circuitry 370 of the second device 310 includes one or more accelerators 378 that cooperate with the hash circuitry 372, signature circuitry 374 and/or verification circuitry 376 to accelerate authentication operations. Examples of accelerators are described in the following paragraphs and with reference to the accompanying drawings.

The various modules of the environment 300 may be embodied as hardware, software, firmware, or a combination thereof. For example, the various modules, circuitry, and other components of the environment 300 may form a portion of, or otherwise be established by, the processor(s) 320 of first device 310 or processor(s) 360 of second device 350, or other hardware components of the devices. As such, in some embodiments, one or more of the modules of the environment 300 may be embodied as circuitry or collection of electrical devices (e.g., an authentication circuitry, a cryptography circuitry, a communication circuitry, a signature circuitry, and/or a verification circuitry). Additionally, in some embodiments, one or more of the illustrative modules may form a portion of another module and/or one or more of the illustrative modules may be independent of one another.

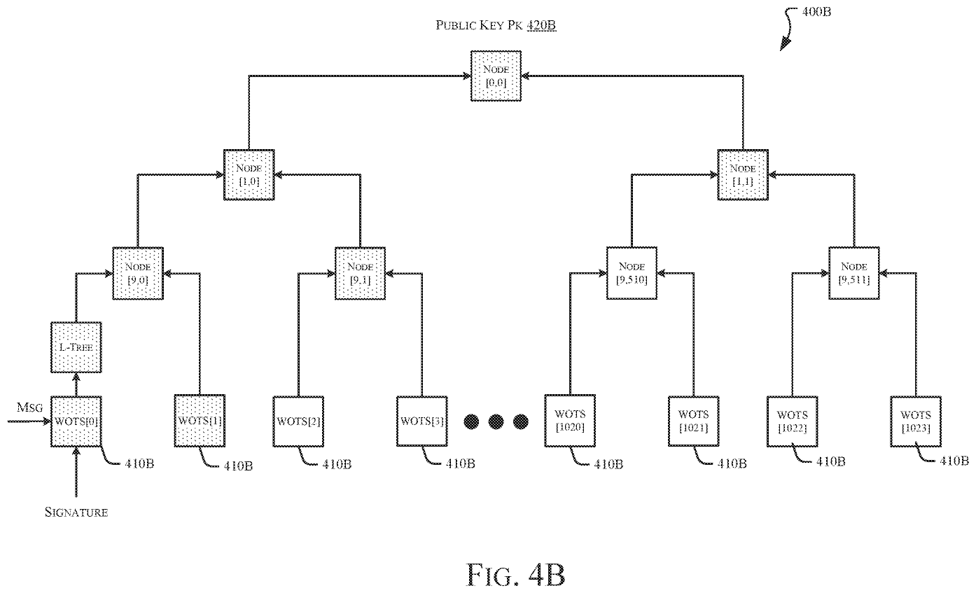

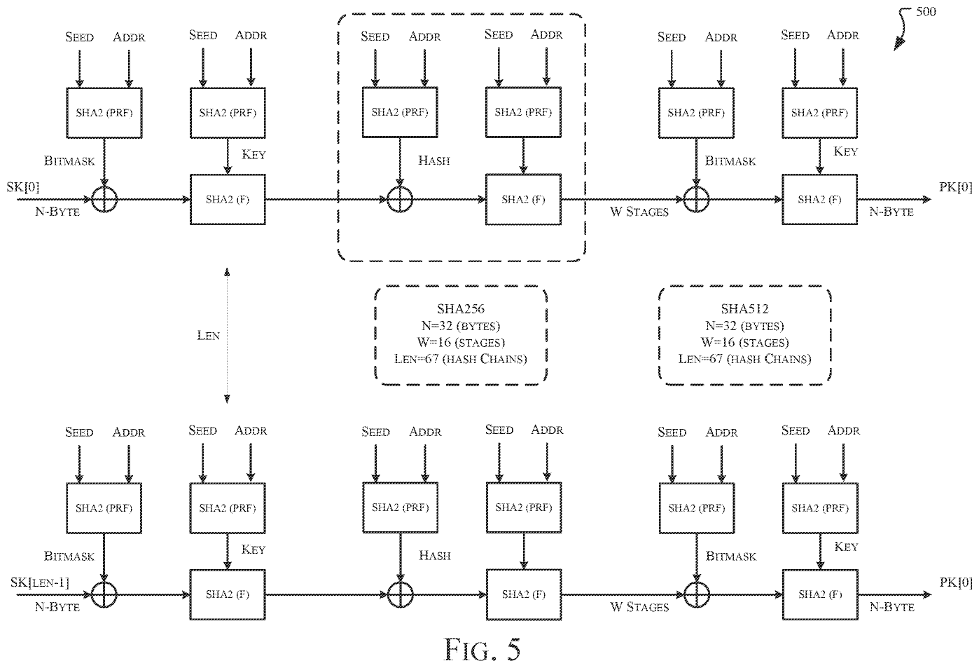

FIG. 4A is a schematic illustration of a Merkle tree structure illustrating signing operations, in accordance with some examples. Referring to FIG. 4A, an XMSS signing operation requires the construction of a Merkle tree 400A using the local public key from each leaf WOTS node 410 to generate a global public key (PK) 420. In some examples the authentication path and the root node value can be computed off-line such that these operations do not limit performance. Each WOTS node 410 has a unique secret key, “sk” which is used to sign a message only once. The XMSS signature consists of a signature generated for the input message and an authentication path of intermediate tree nodes to construct the root of the Merkle tree.

FIG. 4B is a schematic illustration of a Merkle tree structure 400B during verification, in accordance with some examples. During verification, the input message and signature are used to compute the local public key 420B of the WOTS node, which is further used to compute the tree root value using the authentication path. A successful verification will match the computed tree root value to the public key PK shared by the signing entity. The WOTS and L-Tree operations constitute on a significant portion of XMSS sign/verify latency respectively, thus defining the overall performance of the authentication system. Described herein are various pre-computation techniques which may be implemented to speed-up WOTS and L-Tree operations, thereby improving XMSS performance. The techniques are applicable to the other hash options and scale well for both software and hardware implementations.

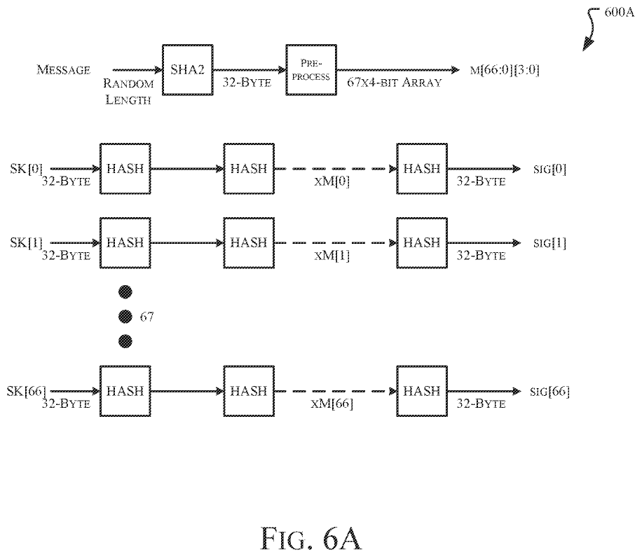

FIG. 5 is a schematic illustration of a compute blocks in an architecture 500 to implement a signature algorithm, in accordance with some examples. Referring to FIG. 5, the WOTS+ operation involves 67 parallel chains of 16 SHA2-256 HASH functions, each with the secret key sₖ[66:0] as input. Each HASH operation in the chain consists of 2 pseudo-random functions (PRF) using SHA2-256 to generate a bitmask and a key. The bitmask is XOR-ed with the previous hash and concatenated with the key as input message to a 3rd SHA2-256 hash operation. The 67×32-byte WOTS public key pk[66:0] is generated by hashing secret key sk across the 67 hash chains.

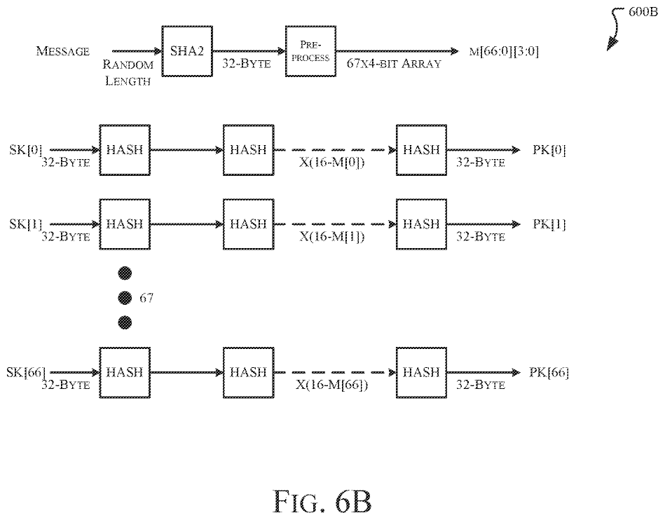

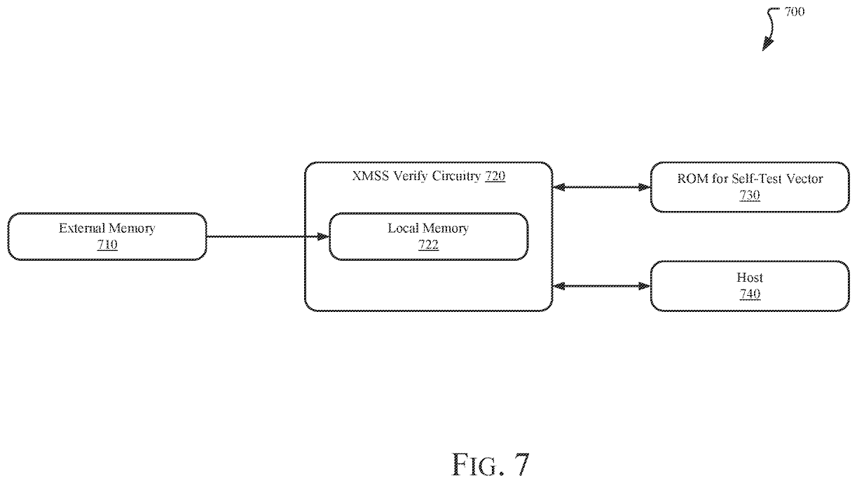

FIG. 6A is a schematic illustration of a compute blocks in an architecture 600A to implement signature generation in a signature algorithm, in accordance with some examples. As illustrated in FIG. 6A, for message signing, the input message is hashed and pre-processed to compute a 67×4-bit value, which is used as an index to choose an intermediate hash value in each chain.

FIG. 6B is a schematic illustration of a compute blocks in an architecture 600B to implement signature verification in a verification algorithm, in accordance with some examples. Referring to FIG. 6B, during verification, the message is again hashed to compute the signature indices and compute the remaining HASH operations in each chain to compute the WOTS public key pk. This value and the authentication path are used to compute the root of the Merkle tree and compare with the shared public key PK to verify the message.

### XMSS Management

Various electronic devices use cryptography algorithms (e.g., RSA, EC-DSA) to verify authenticity of hardware and/or firmware at boot time, or upon request. As described above, these cryptography algorithms are expected to be broken by quantum computers. The eXtended Merkle Signature Scheme (XMSS) and Leighton-Micali Hash-Based Signatures (LMS) are Hash Based Signature Schemes that are standardized by IETF and recommended by NIST as PQ secure digital signature schemes.

Classical encryption schemes (e.g., RSA, EC-DSA) commonly utilize a 256-bit hash digest for verification. By contrast, XMSS verification schemes require an entire object (i.e., software and/or firmware) image as input to the verify procedure. As a result, a large local memory is required to store the entire object image. Similarly, classical encryption schemes (e.g., ECDSA/RSA) require only a few hundred bytes of memory for a fixed signature. By contrast, a 2 KB fixed signature must be stored hardware to support Federal information processing standards (FIPS) certification. Thus, XMSS verification schemes consume significant memory resources, which can create memory allocation issues in devices that are memory constrained, or in environments in which memory consumption incurs material costs.

To address these and other issues, described herein are technologies and techniques to implement XMSS management to address randomized hashing and Federal information processing standards. In some examples, the techniques described herein help to define an efficient XMSS hardware engine that addresses the memory overhead generated by XMSS verification requirements and that meets federal information processing standards (FIPS) requirements.

In some examples described herein the entire object (e.g., firmware and/or hardware) image is stored into a memory that is external to the hardware that defines the XMSS verification circuitry. The image may be streamed into a local memory of the hardware that defines the XMSS verification circuitry one block at a time to allow the XMSS verification circuitry to compute the randomized hash required by the SHA256 verification process. This reduces local memory requirements from having to store the entire object image (e.g., 16 KB) to only a single SHA256 block (64B). Further, to address FIPS requirements, the 2 KB test-vector required by FIPS may be stored into a ROM and loaded into local memory during a power-on self-test operation. This reduces the required number of hardware gates by about 48 k gates (i.e., three gates per bit to store in hardware). Additionally, to address FIPS requirement of atomic execution, the XMSS verification circuitry may disable interrupts during XMSS-verification process.

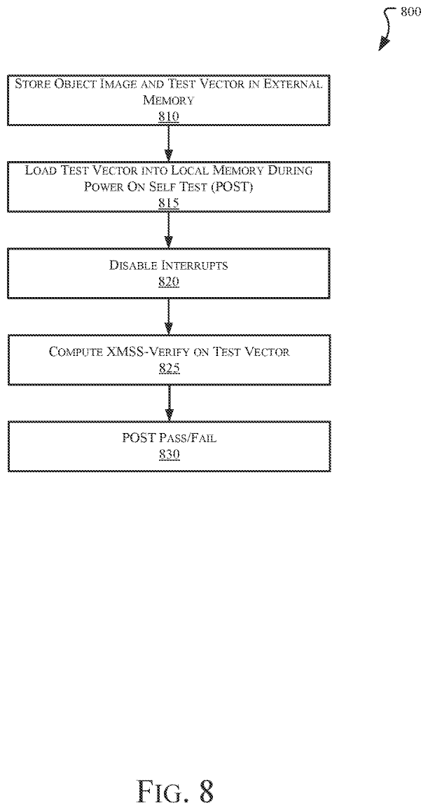

FIG. 7 is a schematic illustration of compute blocks in an architecture 700 to implement XMSS management to address randomized hashing and federal information processing standards, in accordance with some examples. In some examples the compute blocks depicted in FIG. 7 may be a part of the verification circuitry 336 and/or 376 depicted in FIG. 3. Referring to FIG. 7, in some examples the architecture 700 comprises an external memory 710 communicatively coupled to an XMSS verify circuitry 720 comprising a local memory 722, which is in turn communicatively coupled to an external ROM 730 that stores a self-test vector and a host device 740.

In some examples the XMSS verify circuit 720 is to receive a randomized SHA256 message digest, e.g., from the local memory 722 and to verify the XMSS signature on the SHA256 digest. While the particular validation technique implemented by the XMSS verify circuit 724 is not critical to the subject matter described herein, examples of validation techniques are described with reference to FIG. 6A and FIG. 6B, above.

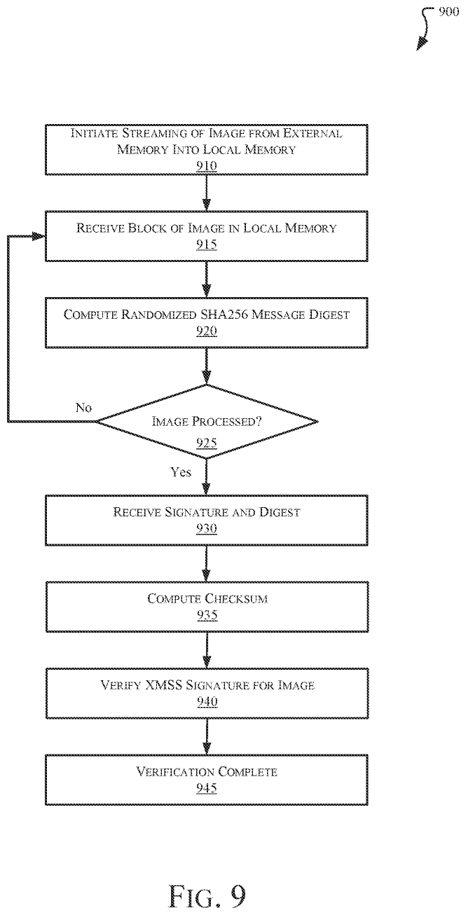

Operations implemented by the architecture 700 are described with reference to FIG. 8., which is a flowchart illustrating operations in a method 800 to implement power on self test (POST) processing, in accordance with some examples, in accordance with some examples. Referring to FIG. 8, at operation 810 an image of an object (e.g., an image of a firmware file or software file) is stored in the external memory 710. At operation 815 a test vector is loaded into local memory from the ROM for self test vector 730. At operation 820 interrupts are disabled for the time period during which XMSS verification is to be executed.

At operation 825 an XMSS verify operation is computed on the test vector loaded in operation 815. In some examples this power on self test (POST) is performed on a fixed randomized digest of size 256-bit which is come with the test vector from the external ROM storage 730. Upon receiving the test vector that includes the digest, the respective fixed signature and the fixed public key, the engine performs the XMSS Verify and produce the POST PASS/FAIL result, at operation 830. If the POST test has passed, then the host 740 makes the XMSS-verify circuitry 720 ready and opens up an interface for users. Otherwise, the host 740 disables the XMSS-verify circuitry 720.

In some examples a 12-bit checksum value is computed on the 256-bit randomized message digest. For example, the checksum may be computed by circuitry in the XMSS verify circuitry 720, which saves external complexity and computation latency by reducing external memory/bus assesses. Also, this generates a robust XMSS implementation because the checksum part also become part of the atomic execution inside the XMSS verify circuitry 720.

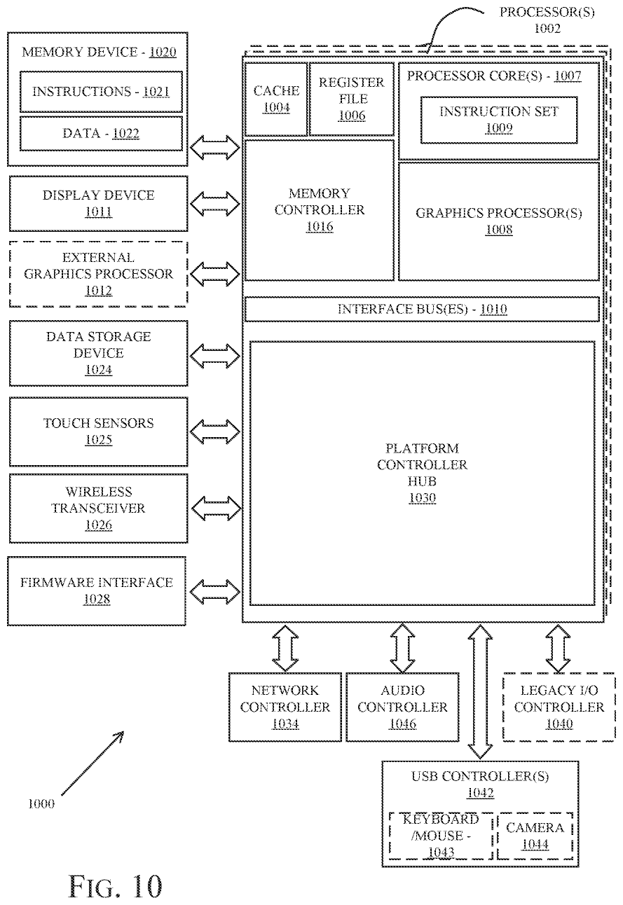

FIG. 9 is a flowchart illustrating operations in a method to implement XMSS management to address randomized hashing and federal information processing standards, in accordance with some examples. At operation streaming of the object image from external memory 710 is initiated. At operation 915 a block of the image is received in the XMSS verify circuitry 720. In some examples the block is dimensioned to correspond to a single SHA256 block, i.e., 64B. At operation 920 the host computes the randomized hash of the Image/Message to be verified. In one embodiment, the host can utilize a SHA256 engine that resides within he XMSS-Verify circuitry 720 for computing the randomized message hashing. In other embodiments, the host can utilize an external SHA256 engine for the randomized message hashing. Similarly, in other embodiments, the host can compute the randomized message hashing by software execution.

If, at operation 925, the entire image has not been processed then control passes back to operation 915 and the next block is received. By contrast, if at operation 925 the entire image has been processed then the host provides the randomized message digest to the XMSS verifier circuitry 720, the respective XMSS signature is written into the XMSS verify circuitry local memory 722, and then the host requests the XMSS verify circuitry 720 for signature verification. At operation 930 the XMSS verify circuitry 720 receives the signature and digest. At operation 935 the checksum is computed, and at operation 940 XMSS verify circuitry 720 verifies the XMSS signature, at which point verification is complete (operation 945).

In some examples the following operations for POST test may be performed by ROM and XMSS hardware at approximately the same time:

Operation 1: byte[n] M′=H_msg(r∥getRoot(PK)∥(toByte(idx_sig, n)), M)
Operation 2: byte[n] node=XMSS_rootFromSig(idx_sig, sig_ots, auth, M′, getSEED(PK), ADRS)

Of the multiple steps in XMSS_rootFromSig( ), the implementation can also run steps by different blocks simultaneously. Known intermediate input/output is hardcoded in the different blocks. Alternatively, intermediate input/output can be supplied separately to all different blocks contemporaneously from ROM.

FIG. 9 illustrates an embodiment of an exemplary computing architecture that may be suitable for implementing various embodiments as previously described. In various embodiments, the computing architecture 900 may comprise or be implemented as part of an electronic device. In some embodiments, the computing architecture 900 may be representative, for example of a computer system that implements one or more components of the operating environments described above. In some embodiments, computing architecture 900 may be representative of one or more portions or components of a DNN training system that implement one or more techniques described herein. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 includes one or more processors 902 and one or more graphics processors 908, and may be a single processor desktop system, a multiprocessor workstation system, or a server system having a large number of processors 902 or processor cores 907. In on embodiment, the system 900 is a processing platform incorporated within a system-on-a-chip (SoC or SOC) integrated circuit for use in mobile, handheld, or embedded devices.

An embodiment of system 900 can include, or be incorporated within a server-based gaming platform, a game console, including a game and media console, a mobile gaming console, a handheld game console, or an online game console. In some embodiments system 900 is a mobile phone, smart phone, tablet computing device or mobile Internet device. Data processing system 900 can also include, couple with, or be integrated within a wearable device, such as a smart watch wearable device, smart eyewear device, augmented reality device, or virtual reality device. In some embodiments, data processing system 900 is a television or set top box device having one or more processors 902 and a graphical interface generated by one or more graphics processors 908.

In some embodiments, the one or more processors 902 each include one or more processor cores 907 to process instructions which, when executed, perform operations for system and user software. In some embodiments, each of the one or more processor cores 907 is configured to process a specific instruction set 909. In some embodiments, instruction set 909 may facilitate Complex Instruction Set Computing (CISC), Reduced Instruction Set Computing (RISC), or computing via a Very Long Instruction Word (VLIW). Multiple processor cores 907 may each process a different instruction set 909, which may include instructions to facilitate the emulation of other instruction sets. Processor core 907 may also include other processing devices, such a Digital Signal Processor (DSP).

In some embodiments, the processor 902 includes cache memory 904. Depending on the architecture, the processor 902 can have a single internal cache or multiple levels of internal cache. In some embodiments, the cache memory is shared among various components of the processor 902. In some embodiments, the processor 902 also uses an external cache (e.g., a Level-3 (L3) cache or Last Level Cache (LLC)) (not shown), which may be shared among processor cores 907 using known cache coherency techniques. A register file 906 is additionally included in processor 902 which may include different types of registers for storing different types of data (e.g., integer registers, floating point registers, status registers, and an instruction pointer register). Some registers may be general-purpose registers, while other registers may be specific to the design of the processor 902.

In some embodiments, one or more processor(s) 902 are coupled with one or more interface bus(es) 910 to transmit communication signals such as address, data, or control signals between processor 902 and other components in the system. The interface bus 910, in one embodiment, can be a processor bus, such as a version of the Direct Media Interface (DMI) bus. However, processor busses are not limited to the DMI bus, and may include one or more Peripheral Component Interconnect buses (e.g., PCI, PCI Express), memory busses, or other types of interface busses. In one embodiment the processor(s) 902 include an integrated memory controller 916 and a platform controller hub 930. The memory controller 916 facilitates communication between a memory device and other components of the system 900, while the platform controller hub (PCH) 930 provides connections to I/O devices via a local I/O bus.

Memory device 920 can be a dynamic random-access memory (DRAM) device, a static random-access memory (SRAM) device, flash memory device, phase-change memory device, or some other memory device having suitable performance to serve as process memory. In one embodiment the memory device 920 can operate as system memory for the system 900, to store data 922 and instructions 921 for use when the one or more processors 902 executes an application or process. Memory controller hub 916 also couples with an optional external graphics processor 912, which may communicate with the one or more graphics processors 908 in processors 902 to perform graphics and media operations. In some embodiments a display device 911 can connect to the processor(s) 902. The display device 911 can be one or more of an internal display device, as in a mobile electronic device or a laptop device or an external display device attached via a display interface (e.g., DisplayPort, etc.). In one embodiment the display device 911 can be a head mounted display (HMD) such as a stereoscopic display device for use in virtual reality (VR) applications or augmented reality (AR) applications.

In some embodiments the platform controller hub 930 enables peripherals to connect to memory device 920 and processor 902 via a high-speed I/O bus. The I/O peripherals include, but are not limited to, an audio controller 946, a network controller 934, a firmware interface 928, a wireless transceiver 926, touch sensors 925, a data storage device 924 (e.g., hard disk drive, flash memory, etc.). The data storage device 924 can connect via a storage interface (e.g., SATA) or via a peripheral bus, such as a Peripheral Component Interconnect bus (e.g., PCI, PCI Express). The touch sensors 925 can include touch screen sensors, pressure sensors, or fingerprint sensors. The wireless transceiver 926 can be a Wi-Fi transceiver, a Bluetooth transceiver, or a mobile network transceiver such as a 3G, 4G, or Long Term Evolution (LTE) transceiver. The firmware interface 928 enables communication with system firmware, and can be, for example, a unified extensible firmware interface (UEFI). The network controller 934 can enable a network connection to a wired network. In some embodiments, a high-performance network controller (not shown) couples with the interface bus 910. The audio controller 946, in one embodiment, is a multi-channel high definition audio controller. In one embodiment the system 900 includes an optional legacy I/O controller 940 for coupling legacy (e.g., Personal System 2 (PS/2)) devices to the system. The platform controller hub 930 can also connect to one or more Universal Serial Bus (USB) controllers 942 connect input devices, such as keyboard and mouse 943 combinations, a camera 944, or other USB input devices.

The following pertains to further examples.

Example 1 is an apparatus, comprising verification circuitry to store an object image in a computer readable memory external to an XMSS verifier circuitry; and process the object image by repeating operations to receive, in a local memory of the XMSS verifier circuitry, a fixed-sized block of data from the object image; and process the fixed-sized block of data; and verify the XMSS signature of the entire object image.

In Example 2, the subject matter of Example 1 can optionally include an arrangement wherein the object image comprises at least one of a firmware image or a software image.

In Example 3, the subject matter of any one of Examples 1-2 can optionally include circuitry to load a test vector into the local memory of the XMSS verifier circuitry.

In Example 4, the subject matter of any one of Examples 1-3 can optionally include an arrangement wherein the test vector comprises at least 2 KB of data.

In Example 5, the subject matter of any one of Examples 1-4 can optionally include circuitry to compute a randomized SHA256 hash of the fixed-sized block of data and perform a verification operation using the randomized SHA256 hash.

In Example 6, the subject matter of any one of Examples 1-5 can optionally include an arrangement wherein the verification operation comprises at least one of an XMSS verification operation or an LMS verification operation.

In Example 7, the subject matter of any one of Examples 1-6 can optionally include circuitry to disable interrupts during until the object image is verified.

Example 8, is a method comprising storing an object image in a computer readable memory external to an XMSS verifier circuitry; and processing the object image by repeating operations comprising receiving, in a local memory of the XMSS verifier circuitry, a fixed-sized block of data from the object image; and processing the fixed-sized block of data; and verifying the XMSS signature of the entire object image.

In Example 9, the subject matter of any one of Example 8 can optionally include an arrangement wherein the object image comprises at least one of a firmware image or a software image.

In Example 10, the subject matter of any one of Examples 8-9 can optionally include loading a test vector into the local memory of the XMSS verifier circuitry.

In Example 11 the subject matter of any one of Examples 8-10 can optionally include an arrangement wherein the test vector comprises at least 2 KB of data.

In Example 12, the subject matter of any one of Examples 8-111 can optionally include computing a randomized SHA256 hash of the fixed-sized block of data and performing a verification operation using the randomized SHA256 hash.

In Example 13, the subject matter of any one of Examples 8-12 can optionally include an arrangement wherein the verification operation comprises at least one of an XMSS verification operation or an LMS verification operation.

In Example 14, the subject matter of any one of Examples 8-13 can optionally include disabling interrupts during until the object image is verified.

In Example 15, is a non-transitory computer-readable medium comprising instructions which, when executed by a processor, configure the processor to store an object image in a computer readable memory external to an XMSS verifier circuitry; and process the object image by repeating operations to receive, in a local memory of the XMSS verifier circuitry, a fixed-sized block of data from the object image; and processing the fixed-sized block of data; and verifying the object image.

In Example 16, the subject matter of Example 15 can optionally include an arrangement wherein the object image comprises at least one of a firmware image or a software image.

In Example 17, the subject matter of any one of Examples 15-16 can optionally include instructions which, when executed by a processor, configure the processor to load a test vector into the local memory of the XMSS verifier circuitry.

In Example 18, the subject matter of any one of Examples 15-17 can optionally include an arrangement wherein the test vector comprises at least 2 KB of data.

In Example 19, the subject matter of any one of Examples 15-18 can optionally include instructions which, when executed by a processor, configure the processor to compute a randomized SHA256 hash of the fixed-sized block of data and perform a verification operation using the randomized SHA256 hash.

In Example 20, the subject matter of any one of Examples 15-19 can optionally include an arrangement wherein the verification operation comprises at least one of an XMSS verification operation or an LMS verification operation.

In Example 21, the subject matter of any one of Examples 15-19 can optionally include instructions which, when executed by a processor, configure the processor to disable interrupts during until the object image is verified.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition, “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising verification circuitry to:
store an object image in a computer readable memory external to an Extended Merkle Signature Scheme (XMSS) verifier circuitry; and
process the object image by repeating operations to:
receive, in a local memory of the XMSS verifier circuitry, a fixed-sized block of data from the object image; and
process the fixed-sized block of data; and
verify the XMSS signature of the entire object image.

2. The apparatus of claim 1, wherein the object image comprises at least one of a firmware image or a software image.

3. The apparatus of claim 2, further comprising circuitry to:
load a test vector into the local memory of the XMSS verifier circuitry.

4. The apparatus of claim 3, wherein the test vector comprises at least 2 KB of data.

5. The apparatus of claim 1, further comprising circuitry to:
compute a randomized Secure Hash Algorithm-256 (SHA256) hash of the fixed-sized block of data; and
perform a verification operation using the randomized SHA256 hash.

6. The apparatus of claim 5, wherein the verification operation comprises at least one of an XMSS verification operation or a Leighton/Micali Signature (LMS) verification operation.

7. The apparatus of claim 1, further comprising circuitry to:
disable interrupts during until the object image is verified.

8. A method, comprising:
storing an object image in a computer readable memory external to an Extended Merkle Signature Scheme (XMSS) verifier circuitry; and
processing the object image by repeating operations comprising:
receiving, in a local memory of the XMSS verifier circuitry, a fixed-sized block of data from the object image; and
processing the fixed-sized block of data; and
verifying the XMSS signature of the entire object image.

9. The method of claim 8, wherein the object image comprises at least one of a firmware image or a software image.

10. The method of claim 9, further comprising:
loading a test vector into the local memory of the XMSS verifier circuitry.

11. The method of claim 10, wherein the test vector comprises at least 2 KB of data.

12. The method of claim 8, further comprising:
computing a randomized Secure Hash Algorithm-256 (SHA256) hash of the fixed-sized block of data; and
performing a verification operation using the randomized SHA256 hash.

13. The method of claim 12, wherein the verification operation comprises at least one of an XMSS verification operation or a Leighton/Micali Signature (LMS) verification operation.

14. The method of claim 8, further comprising:
disabling interrupts during until the object image is verified.

15. A non-transitory computer-readable medium comprising instructions which, when executed by a processor, configure the processor to:
store an object image in a computer readable memory external to an Extended Merkle Signature Scheme (XMSS) verifier circuitry; and
process the object image by repeating operations to:
receive, in a local memory of the XMSS verifier circuitry, a fixed-sized block of data from the object image; and
processing the fixed-sized block of data; and
verifying the object image.

16. The non-transitory computer-readable medium of claim 15, wherein the object image comprises at least one of a firmware image or a software image.

17. The non-transitory computer-readable medium of claim 16, further comprising instructions which, when executed by the processor, configure the processor to:
load a test vector into the local memory of the XMSS verifier circuitry.

18. The non-transitory computer-readable medium of claim 17, wherein the test vector comprises at least 2 KB of data.

19. The non-transitory computer-readable medium of claim 15, further comprising instructions which, when executed by the processor, configure the processor to:
compute a randomized Secure Hash Algorithm-256 (SHA256) hash of the fixed-sized block of data; and
perform a verification operation using the randomized SHA256 hash.

20. The non-transitory computer-readable medium of claim 19, wherein the verification operation comprises at least one of an XMSS verification operation or a Leighton/Micali Signature (LMS) verification operation.

21. The non-transitory computer-readable medium of claim 15, further comprising instructions which, when executed by the processor, configure the processor to:
disable interrupts during until the object image is verified.
